(19) United States
(12) Patent Application Publication
(10) Pub. No.: US 2015/0038205 A1
(43) Pub. Date: Feb. 5, 2015

(54) MONETIZATION OF SPELLING GAMES BY ASSOCIATING WORDS WITH ADVERTISERS

(71) Applicants: Veronica Wiechers DULUK, Palo Alto, CA (US); Jerome F. DULUK, Jr., Palo Alto, CA (US)

(72) Inventors: Veronica Wiechers DULUK, Palo Alto, CA (US); Jerome F. DULUK, Jr., Palo Alto, CA (US)

(21) Appl. No.: 14/303,458

(22) Filed: Jun. 12, 2014

Related U.S. Application Data
(60) Provisional application No. 61/958,558, filed on Jul. 31, 2013.

(51) Int. Cl. G07F 17/32

(52) U.S. Cl. CPC G07F 17/3295; G07F 17/3255
USPC 463/9

(57) ABSTRACT

One embodiment of the present invention includes distributing bonus awards associated with a spelling game. A spelling game server system defines a first subset of letters included in a plurality of letters. A spelling game server system defines a set of allowed words that includes a bonus word. A spelling game server system receives one or more letters from the first subset of letters, where the subset of letters includes at least one newly spelled word, and the at least one newly spelled word is included in the set of allowed words. A spelling game server system awarding a first reward based on the at least one newly spelled word, wherein the first reward includes a bonus reward when the at least one newly spelled word includes at least a portion of the bonus word.

### CROSS REFERENCE TO RELATED APPLICATIONS

This application claims the benefit of United States provisional patent application entitled “WORD-SPELLING GAMES WITH PAID ADVERTISING WORDS,” Ser. No. 61/958,558, filed Jul. 31, 2013.

### BACKGROUND OF THE INVENTION

1. Field of the Invention

Embodiments of the present invention relate generally to computer-based spelling games, and, more specifically, to monetization of spelling games by associating words with advertisers.

2. Description of Related Art

Decades ago, the board game SCRABBLE was invented, and many other spelling games have also been invented, such as SPILL AND SPELL, BANANAGRAMS, and UPWORDS, to name a few. The name SCRABBLE is a trademark of Hasbro, Inc. in the United States and Canada; elsewhere, the name SCRABBLE is trademarked by Mattel. Other games listed herein are trademarked by their respective owners.

With the advent of computer devices, many spelling games, including SCRABBLE-like games, are played on various computing devices, such as desktop computers, laptop computers, tablets, phones, and various other mobile devices. The games are often over the internet. For example, the company Zynga provides the game WORDS WITH FRIENDS, where players play the game in a web browser or an application, also referred to herein as an “app,” on a tablet or mobile device, against other players over the internet. Generally, players see a virtual game board, either in the app or in a window on the computing device, and take turns spelling words.

Even though many internet-based spelling games have attracted many players, game providers have difficulty in making money. Many of these internet spelling games may be played for free, resulting in reduced profitability. Providers of these internet-based spelling games currently make money through various means, including, without limitation, sale or licensing of a copy of the game, such as an app; advertising fees from sponsors; and selling game options to players.

The sale or licensing of a copy of the game, or app, is direct revenue, but since many competitive games are offered for free over the internet, a copy of a game typically sells for only a few dollars, and sales compete for players with the availability of free games.

Advertising is the dominant way game providers make money. Advertising associated with game applications may include static or moving advertisement images, usually with a link to a web site, that reside next to the virtual game board of the game, in the same computer window or inside the app. Most game players ignore the static or moving advertisement images. Alternatively, a video pop-up window may display a TV-commercial-like advertisement, and these pop-up windows generally obscure the virtual game board. Pop-up video windows are aggravating for game players, because the pop-up windows draw the player's attention away from the game, and delay playing of the game. Most game players find pop-up video windows annoying, but players put up with the inconvenience because the game is offered by the provider for free.

Selling game options is another way for game providers to make money, even though the actual game application may be available for free. For example, the FACEBOOK WORDS WITH FRIENDS Store sells the following products: WORD-O-METER, which provides a measure of the strength of the word a player is about to play; NO MORE VIDEO ADS, which stops video advertisements from playing during a game; and TILE PILE, which tells a player which tiles are not yet played. Some game options, such as FACEBOOK's WORD-O-METER and TILE PILE are regarded by at least some players as paying for cheating, because they give players an advantage in the game. The options that avoid ads, such as FACEBOOK's NO MORE VIDEO ADS, are essentially forcing something annoying onto the players, and then making them pay to avoid the annoyance. Such tactics do not add to enjoyment of the game, and are not looked upon positively by some game players. Many players do not buy game options, because the game options typically do not add anything to the game play.

As the foregoing illustrates, what is needed is a more effective way to increase revenue associated with a game application.

### SUMMARY OF THE INVENTION

One embodiment of the present invention sets forth a method for distributing bonus awards associated with a spelling game. The method includes defining a first subset of letters included in a plurality of letters. The method further includes defining a set of allowed words that includes a bonus word. The method further includes receiving one or more letters from the first subset of letters, where the subset of letters includes at least one newly spelled word, and the at least one newly spelled word is included in the set of allowed words. Finally, the method further includes awarding a first reward based on the at least one newly spelled word, where the first reward includes a bonus reward when the at least one newly spelled word includes at least a portion of the bonus word.

Other embodiments include, without limitation, a computer-readable medium that includes instructions that enable a processing unit to implement one or more aspects of the disclosed methods. Other embodiments include, without limitation, a subsystem that includes a processing unit configured to implement one or more aspects of the disclosed methods as well as a computing system configured to implement one or more aspects of the disclosed methods.

### BRIEF DESCRIPTION THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram illustrating a network system architecture configured to implement one or more aspects of the present invention;

FIG. 1B is a block diagram illustrating a computer system configured to implement one or more aspects of the present invention;

FIG. 2 is a conceptual diagram of a user interface layout on a computing device, showing a spelling game, according to one embodiment of the present invention;

FIG. 3 is a conceptual diagram of a user interface layout showing buttons for selecting a bonus word, along with the bonus rewards, also called prizes, associated with the words, according to one embodiment of the present invention;

FIGS. 4A-4B set forth a flow diagram of method steps for distributing bonus awards to players of a spelling game, according to one embodiment of the present invention; and

FIG. 5 sets forth a flow diagram of method steps for distributing bonus awards to players of a spelling game, according to another embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

Advertisers want their brand to be placed into the minds of consumers. For example, if the target brand is “TECHRON” (TECHRON is a registered trademark of Chevron Intellectual Property LLC), then the advertiser would like consumers thinking: “TECHRON, TECHRON, TECHRON, . . . ” Television commercials attempt to do this, with mixed success. In the present invention, advertisers pay to have their brand associated with a bonus reward in a spelling game on a computing device, for example, a SCRABBLE-like game. To win the bonus reward, the consumers who play the game continuously think of the advertiser's brand word, in order to look for opportunities for spelling the brand word and winning the bonus reward. Bonus rewards may take any technically feasible form, including, without limitation, cash money, discount coupons, tickets to events, free products, or advertising merchandise (e.g., coffee cups and tee-shirts).

SCRABBLE is a well-known game where players take turns playing letters to spell words, where the letters are laid on a bounded grid, with each letter of the alphabet being assigned a point value, and there being a fixed number of letters available to be played during the entire game. The approach described herein is not limited to versions of SCRABBLE-like games, and may be applied to any spelling game. For convenience of description, the “SCRABBLE-like” game refers to any suitable spelling game that employs the techniques described herein.

Game providers distribute the game to consumers, who play the game over the internet, or as an app on a tablet or other mobile device, as players. Game providers may host the game on their own web site, or host the game through another provider's web site, license the game as an app, or provide indirect access to the game through another provider's web site. For example, Zynga's WORDS WITH FRIENDS is accessed via FACEBOOK's web site, and is also available as an app from the iTunes store. Providers may also sell or license the game software for installation on computing devices. Various providers may work together and split the collected fees.

Each player sees the letters he may play, and a game board with previously spelled words, formed from previously played letters. When the player's turn in the game comes, the player may play his letters to form newly spelled words, which, in some embodiments change the previously spelled words.

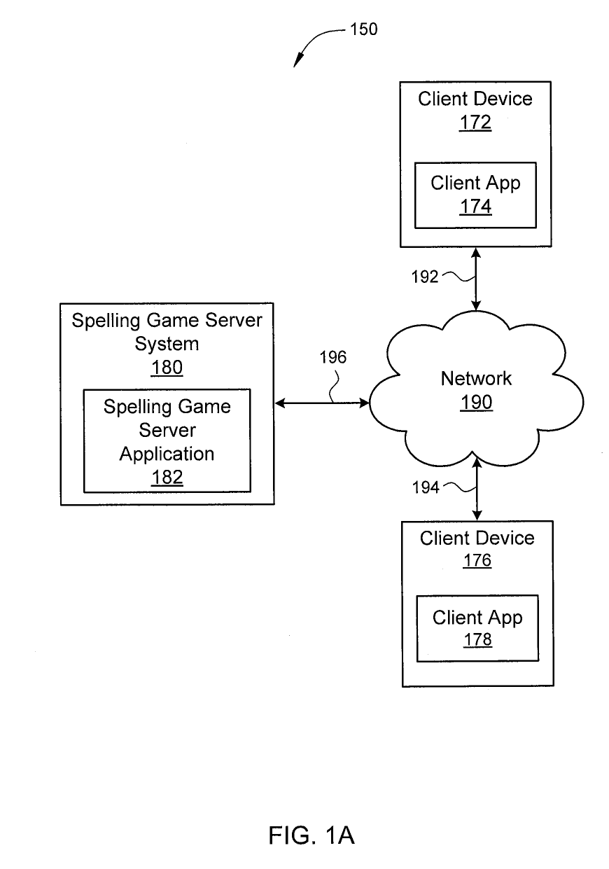

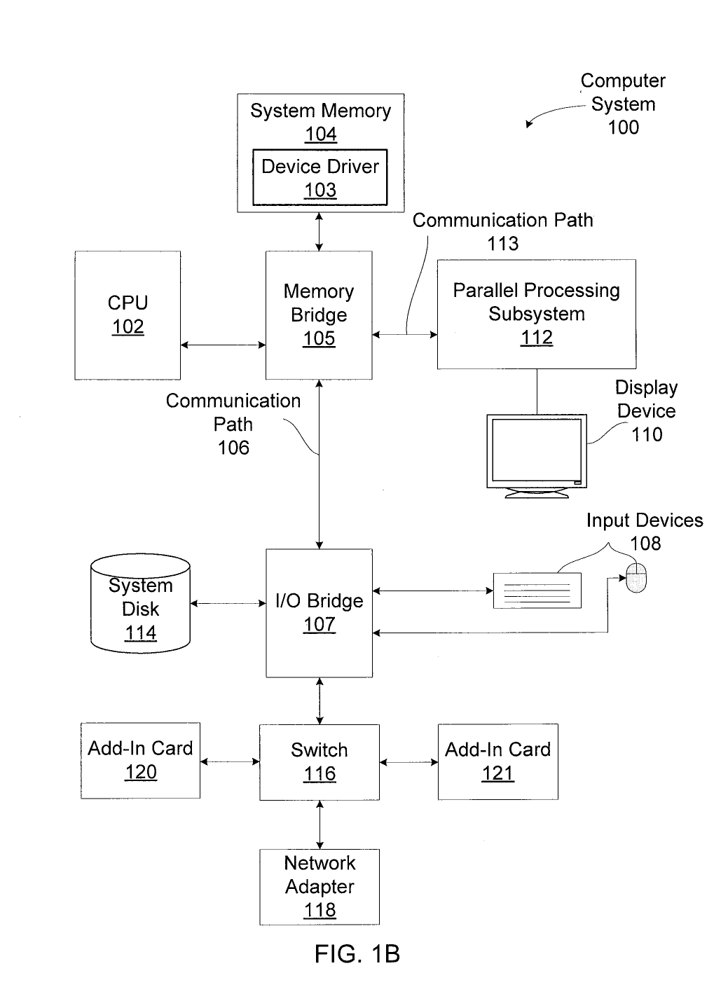

FIG. 1A is a block diagram illustrating a network system architecture 150 configured to implement one or more aspects of the present invention. As shown, the networked computer system 150 includes client devices 172 and 176 connected to a spelling game server system 180 via a network 190. The network 190 may be any suitable environment to enable communications among remotely located computer systems, including, without limitation, a LAN (Local Area Network) and a WAN (Wide Area Network).

The client devices 172 and 176 are configured to execute client applications (client app) 144 and 148, respectively. The client applications 174 and 178 are configured to communicate with the spelling game server system 180 to initiate a spelling game and to submit turns to the spelling game server system 180 at the request of a user, or player, as further described herein. Each of the client devices 172 and 176 may participate in separate spelling games under control of the spelling game server system 180. Alternatively, the client devices 172 and 176 may participate in a multiplayer spelling game under control of the spelling game server system 180. The client devices 172 and 176 communicate with the spelling game server system 180 over the network 190 via communications link 192 and 194, respectively.

The spelling game server system 180 administers single player and multiplayer spelling games for users of various client devices, such as client devices 172 and 176. The spelling game server system 180 is configured to execute a spelling game server application 182. The spelling game server application 182 is configured to communicate with the client devices 172 and 176 to receive turns as submitted by the client applications 174 and 178, respectively. In addition, the spelling game server application 182 is configured to communicate with the client devices 172 and 176 to distribute awards to the client applications 174 and 178, respectively, when certain conditions are met, as further described herein. The spelling game server system 180 communicates with the client devices 172 and 176 over the network 190 via communications link 196.

It will be appreciated that the system shown herein is illustrative and that variations and modifications are possible. For example, although the spelling game is described herein in the context of a SCRABBLE-like game, the disclosed techniques could be employed with any technically feasible spelling game that employs a particular set of game rules. In one embodiment, the spelling game server system 180 may select a dictionary for use during the game before the game begins. Alternatively, the players may select a dictionary by unanimous or majority vote. One such dictionary is the public domain word list known as the Enhanced North American Benchmark Lexicon (ENABLE), although any suitable dictionary may be used. Players may form one or more allowed words during their respective turns, where allowed words are words included in the selected dictionary plus bonus words. Allowed words may include all words in the selected dictionary that are a part of speech, including, without limitation, words of foreign origin, archaic words, obsolete words, colloquial words, slang words. Certain words may be disallowed, including, without limitation, proper nouns, abbreviations, prefixes and suffixes standing alone, and words requiring a hyphen or an apostrophe, unless such words are also bonus words.

The spelling game server system 180 selects the player who will play the first turn using any technically feasible approach, including, without limitation, the first person who signed up for a particular game, or a player selected at random. The second, third, etc. players may be similarly selected. Each player may receive a fixed quantity of letter tiles, such as seven letter tiles, from a pool of letter tiles managed by the spelling game server system 180. The first player places two or more letter tiles on the game board vertically or horizontally, thereby forming a word. The spelling game server system 180 may disallow diagonally-placed words. When the first player indicates that his or her turn is complete, the spelling game server system 180 computes a score for the first player. The spelling game server system 180 draws additional letter tiles from the letter tile pool to replace the letter tiles placed on the game board by the first player.

Play may pass to the second player and to each successive player in turn. Each player adds one or more letter tiles to the letter tiles already places on the game board, thereby forming one or more new words. Each word placed on the game board, after the first word, may share at least one tile with an existing word on the board. All letter tiles played on a turn may be placed in a single row horizontally or in a single column vertically on the game board, thereby forming at least one complete word. If a horizontally-placed word touches multiple adjacent tiles, thereby forming one or more new vertical words, the resulting vertical words may also be included in the allowed words. Likewise, if a vertically-placed word touches multiple adjacent tiles, thereby forming one or more new horizontal words, the resulting horizontal words may also be included in the allowed words. The score for the player may include credit for all vertical and horizontal words formed or modified on his or her turn.

If the tile pool contains fewer letter tiles than the quantity of letter tiles played, then the spelling game server system 180 may draw the remaining letter tiles for the current player. In such cases, play may continue until the game ends, but without replacing tiles played on the game board.

Each player may form new words by various approaches. In one example, the player may add one or more letter tiles to a word or letter tiles already placed on the game board. In another example, the player may place a word at right angles to a word already on the game board, where the new word incorporates one of the letter tiles of the word already on the game board. Alternatively, the player may place a word at right angles to a word already on the game board, where the new word adds a letter to the word already on the game board. In yet another example, the player may place a complete word parallel to a word already placed on the game board, such that letter tiles adjacent to the newly placed word form complete words.

The player may not move or replace a letter tile once the letter tile has been placed and scored. The pool of letter tiles may include one or more blank tiles. Such blank tiles may represent any letter or may represent a special character, such as a hyphen, apostrophe, or exclamation point, where a bonus words includes such a special character. The player states the letter or special character represented by the blank tile when the blank tile is placed, and the blank tile may represent that letter or special character for the remainder of the game.

As an alternative to placing one or more letter tiles during a turn, a player may exchange all, some, or none of the currently held letter tiles with a same quantity of letter tiles in the letter tile pool. The player's turn then ends.

Once a player completes a turn, any other player may challenge one or more words placed by the player before the next player starts a turn. If the challenged word or words are not included in the list of allowed words, the spelling game server system 180 may return all of the newly placed tiles to the challenged player, including tiles that are not part of the challenged word or words. The challenged player's turn then ends. If the challenged word or words are included in the list of allowed words, the challenger may lose his or her next turn. The challenger may challenge any or all words made in one play.

The spelling game server system 180 may update a player's score after the player's turn ends. The score value of each letter tile may be indicated by a number associated the letter tile.

The computed score may include the sum of the score values for the letter tiles in each word formed or modified on the player's turn, plus the additional points obtained from placing letter tiles on certain premium squares. A premium square may double or triple the score value for the letter tile placed on the premium square. Alternatively, a premium square may double or triple the score value for the entire word for a word that includes a letter tile placed on the premium square. The spelling game server system 180 may apply letter premiums prior to applying word premiums. If a placed word includes two word premium squares, the spelling game server system 180 may apply one word premium and then successively apply the other word premium. The game server system 180 letter and word premiums count only on the turn in which the corresponding letter tiles are played. On later turns, letter tiles already played on premium squares may count at the original score value.

The score value for a blank tile may be zero, regardless of the letter or special character represented by the blank tile. If a blank tile is played on a premium word square, then the score value of the word may be doubled or tripled, even though the blank tile itself has no score value.

When two or more words are formed in the same turn, the spelling game server system 180 computes the score value for each newly formed word and adds the score values to the player's score. Any letter tile that is in common with more than one word is scored separately for each word—including any premium letter or word score value for the common letter tile. The spelling game server system 180 may add a premium to a player's score, such as 35 or 50 points, if all tiles held by the player are played in a single turn.

The game ends when all letter tiles have been drawn and one player uses his or her last letter tile or when all possible plays have been made. Alternatively, the game may end if three successive turns for each player have occurred with no scoring and at least one player has a non-zero score. When a game ends, each player's score is reduced by the sum of the score values for any letter tiles that remain unplayed. If a player has placed all of his or her letter tiles, then the sum of the other players' unplayed letter tiles is added to that player's score. The player with the highest final score wins the game. In the case of a tie, the player with the highest score before adding or deducting unplayed letter tiles wins.

FIG. 1B is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 is part of a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

In some embodiments, a touch screen (not explicitly shown) may be integrated with the display device 110. In these embodiments, the touch screen in the display device 110 may be communicatively coupled to the I/O bridge 107. The I/O bridge 107 may be configured to receive user input information from the touch screen in the display device 110, and forward the input information to CPU 102 for processing via communication path 106 and memory bridge 105.

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

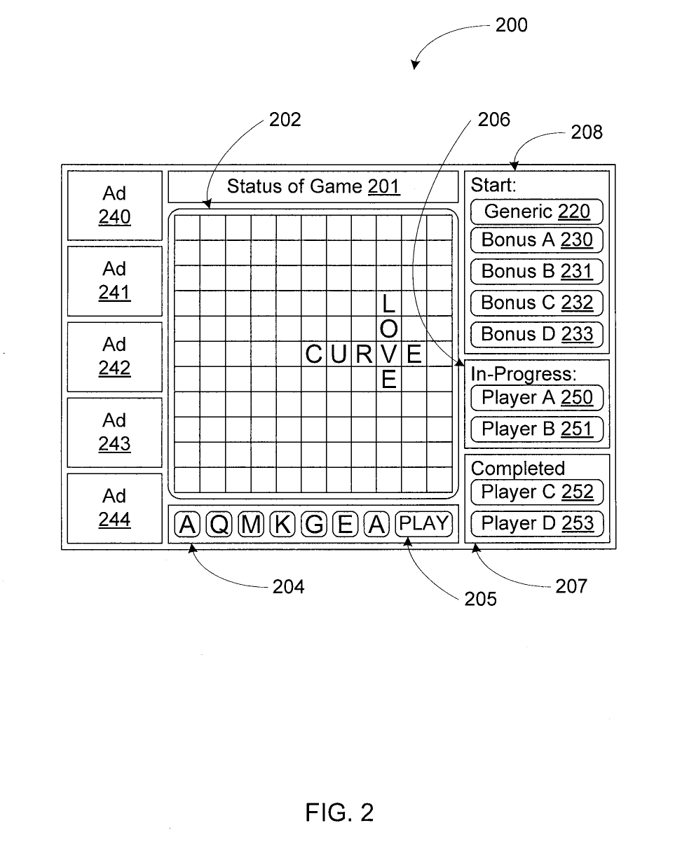

FIG. 2 is a conceptual diagram of a user interface layout 200 on a computing device, showing a spelling game, according to one embodiment of the present invention. Each player sees his own version of the user interface. Within the layout 200, the status area 201 may show the names of the players, current scores, scores from last moves, number of letters remaining, or one or more selectable buttons to chat with other players, plus any other status relating to the current game. The game board area 202 shows the current state of the game board, and FIG. 2 shows two words having been played: “CURVE” and “LOVE.” The game board area 202 may include Double Letter, Triple Letter, etc. and Double Word, Triple Word squares, that increase the reward, or score, for letters and words played, as is known in the game SCRABBLE. The letter tray area 204 shows the letters the player may play to create newly spelled words, and generally include point values for each letter. The letters in the letter tray 204 may be moved onto the game board area, in order for the player to take a turn at the game. The movement may be done via mouse, touch screen, voice command, or any other means to specify movement of letters. The letters may be moved around, to experiment with different words, and the turn is committed when the PLAY button 205 is selected, and a reward, or score, is generated. Alternatively, the PLAY button 205 may invoke pop-ups that verify the move, and/or ask whether to post the move to social media platforms associated with the player. The letter tray area 204 may also include (not shown in FIG. 2) a button to undo a move, a button to exchange all the players letters, concede the game, get spelling hints, check a dictionary, send a message or chat with players, or anything else relevant to the player's turn.

Players may engage in multiple games concurrently. The user interface layout 200 shown in FIG. 2 also includes an area 206 with links to other in-progress games 250 and 251 that are going on concurrently, showing the name of the other player(s) and the scores of those games. The user interface layout 200 also includes an area 207 showing results of completed games, with names of players and scores, possibly with links to those games. The links to other games may open other windows, open another tab in the browser, or change the current view to the other game. The user interface layout 200 may also include (not shown in FIG. 2) buttons to challenge specific other players, or to accept game challenges from other players. The lists of in-progress games 206, completed games 207, challenges, or acceptances may include scroll bars, so that more items may be included in the list than there is room for in the user interface layout 200.

The user interface layout 200 shown in FIG. 2 may additionally (not shown in FIG. 2) include links or menus for account update, help, general chat, links to social media pages, and other games to try. The user interface layout 200 may include a set of ads 240, 241, 242, 243, and 244, where each ad may include static images, moving images, or video, and have a link to a web site.

FIG. 2 also includes a game start area 208, with selectable buttons to start new games. The generic start button 220 starts a conventional game, where the user becomes the first player of a new game and invites other players to join the game. The game start area 208 includes one or more bonus game start buttons 230, 231, 232, and 233 to start games that include bonus rewards that are associated with advertisers, the bonus rewards being awarded when particular words are spelled, the bonus rewards generally being awarded in addition to the normal rewards for spelling words. In some embodiments, the reward may be sent to a mobile device associated with the player as a scan code text or email. The bonus game start buttons 230, 231, 232, and 233 may include the name of the advertiser, the bonus word or words that need to spelled to collect the bonus reward, and the bonus reward or rewards. For example, the bonus game start buttons 230, 231, 232, and 233 start buttons could be: (A) spell “APPLE” and win a $100 coupon toward the purchase of a product from Apple Computer; (B) spell “COKE” or “COLA” and win a $5 coupon toward the purchase of soda; (C) spell “TECHRON” and win a tank of gas; and (D) spell “PAYPAL” and win $5. The list of bonus game start choices 230, 231, 232, and 233 may include scroll bars, so that more items may be included in the list than there is room for in the user interface layout 200.

Any of the in-progress games area 206, completed games area 207, game start area 208, the set of ads 240, 241, 242, 243, and 244, or any other list in the user interface layout 200 may respond to, or be implemented with, pull-down menus, pop-up menus, voice commands, finger motions on a touch screen, or any other means for graphical user interface input.

In some embodiments of the invention, multiple instances of the game are played in parallel, generally with different players, where the awarding of a bonus reward in one game eliminates that bonus from other instances of the game. This becomes a race between multiple players across multiple games, all competing to win a particular bonus reward, also called a “prize,” from a limited pool of bonus rewards. Bonus rewards where players race to see who wins the prize are hereinafter called race bonus rewards. In some embodiments, each game in the multiple instances of the game has a unique bonus word and prize. As a result, each bonus word and prize are unique as to a particular player, and not general to all games played by the player.

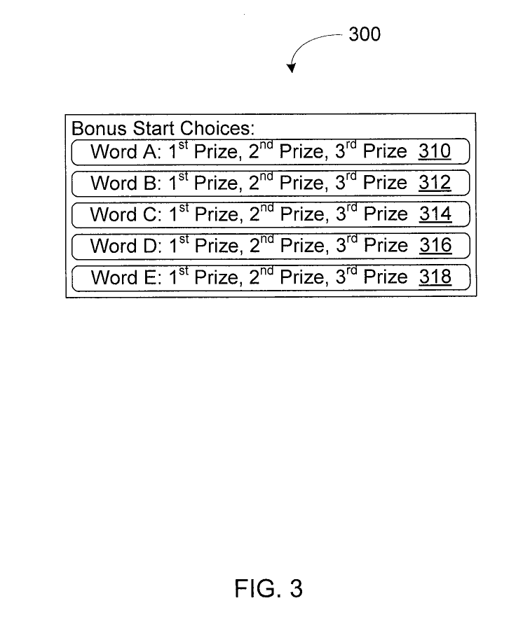

FIG. 3 is a conceptual diagram of a user interface layout 300 showing buttons for selecting a bonus word, along with the bonus rewards, also called prizes, associated with the words, according to one embodiment of the present invention. The user interface layout 300 includes five selectable buttons 310, 312, 314, 316, and 318. Each of the five selectable buttons 310, 312, 314, 316, and 318 specifies one or more bonus words that may result in a bonus reward, and a series of bonus rewards for 1st prize, 2nd prize, 3rd prize, etc. For a particular series of bonus rewards, the player who spells the bonus word first wins the 1st prize bonus reward, the player who spells the bonus word second wins the 2nd prize bonus reward, the player who spells the bonus word third wins the 3rd prize bonus reward, etc. The list of race bonus rewards may respond to, or be implemented with, pull-down menus, pop-up menus, voice commands, finger motions on a touch screen, or any other means for graphical user interface input.

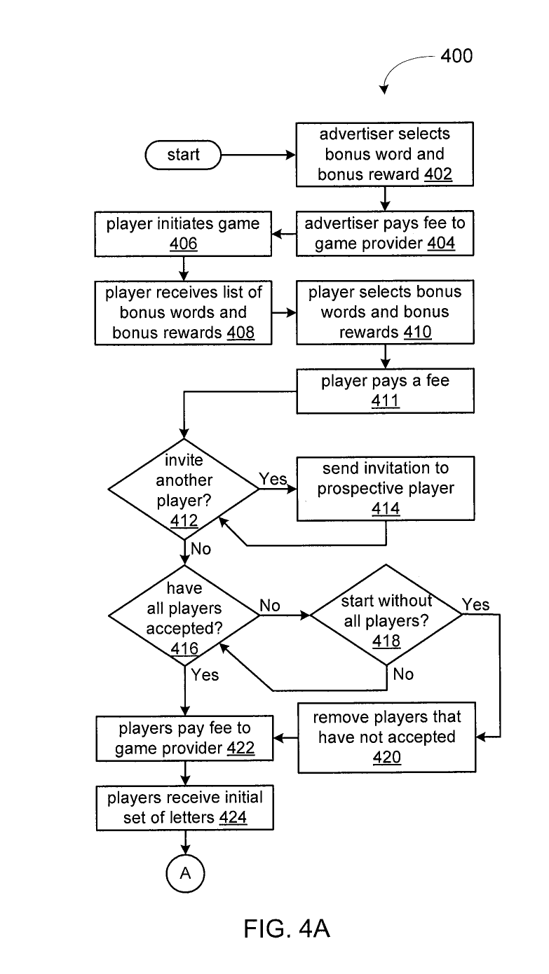

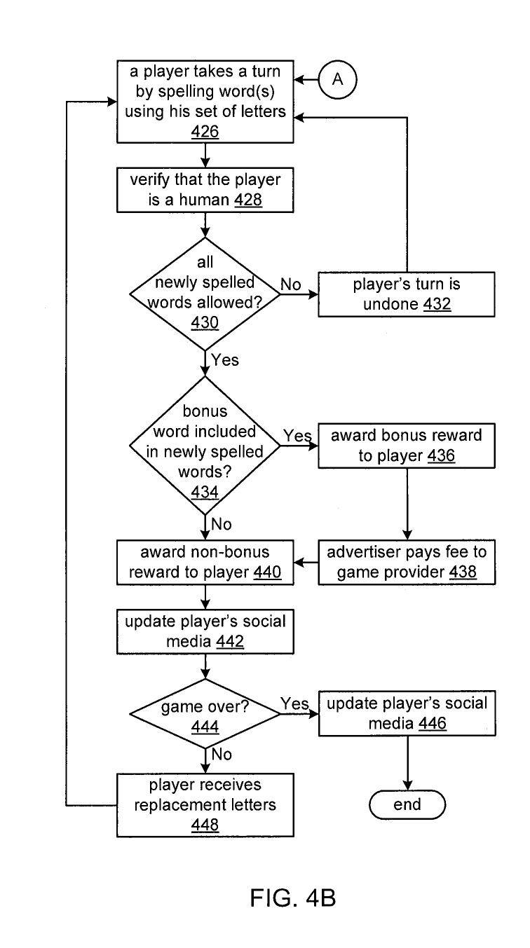

FIGS. 4A-4B set forth a flow diagram of method steps for distributing bonus awards to players of a spelling game, according to one embodiment of the present invention. Although the method steps are described in conjunction with the systems of FIGS. 1A-3, persons of ordinary skill in the art will understand that any system configured to perform the method steps, in any order, is within the scope of the present invention.

A method 400 begins at step 402, where an advertiser selects a bonus word, or words, and bonus reward, or rewards. At step 404, the advertiser pays fee to the game provider, and the bonus word or words become available to players for selection. Fees may be accrued or encompass other financial arrangements between the advertiser and the provider. At step 406, a player initiates a game, and at step 408, the player receives list of bonus words and bonus rewards. At step 410, the player selects a bonus word or words and thereby also selects bonus rewards. At step 411, player pays a fee 411 for having the opportunity to play the game and possibly win a bonus reward. The provider may offer the games to the players for free. At step 412, a player decides whether to invite another player, and if the decision is “yes,” then an invitation is sent to a prospective player, at step 414. Steps 412 and 414 may continue in a loop for as many additional players as desired, subject to rules associated with the particular game offered by the provider, including, without limitation, a total maximum quantity of players or a maximum quantity of invitations per player per game.

If, at step 412, the player decides to not invite another player, the method 400 proceeds to step 416, where the spelling game server system 180 determines whether all players accepted to play the game. If all players have accepted to play the game, then the method 400 proceeds to step 422 where an optional fee may be collected from the players. If, however, all players have not accepted to play the game, then the method 400 proceeds to step 418, where the spelling game server system 180 determines whether to start the game without the acceptance of all players. If the game may not be started without the acceptance of all players, then the method 400 proceeds to step 416, described above. The loop between steps 416 and 418 continues until either all players have accepted, or the game is permitted to begin without the acceptance by the non-accepting players. The decision as to whether to begin without some invited players may be determined via any technically feasible manner, including, without limitation, by the player who initiated the game, by majority or unanimous decision by the players who have already accepted, or by a timeout mechanism.

If the game may begin without the acceptance of all players, then the method 400 proceeds to step 420, where the spelling game server system 180 removes players that have not accepted to play the game. At step 422, an optional fee may be collected from the players, as described above. At step 424, players receive initial set of letters, and the game begins. At step 426, a player takes a turn by spelling one or more words using his set of letters. In order to prevent computer programs from pretending to be human players in order to win excessive bonus rewards, at step 428, the player is verified as being a human being. This verification may be accomplished via any technically feasible approach. For example, the spelling game server system 180 may present the player with a pattern recognition test, where the player is asked to recognize and type randomly placed and rotated letters or numbers placed over a grid. At step 430, the spelling game server system 180 determines whether all the newly spelled words are allowed words. In one embodiment, the allowed words comprise the words from a particular dictionary along with the bonus word or words. If, at step 430, not all the newly spelled words are allowed words, then the method 400 proceeds to step 432, where the spelling game server system 180 rejects the player's turn and the player's letters are removed from the board. In some embodiments, the player may try again, and, in other embodiments, the player loses his turn or decreases the number of tries he is allowed.

If, at step 430, all the newly spelled words are allowed words, the method 400 proceeds to step 434, where the spelling game server system 180 determines whether a bonus word is included in the newly spelled words. If a bonus word is included in the newly spelled words, then the method 400 proceeds to step 436, where the spelling game server system 180 awards a bonus reward to the player. At step 438, the spelling game server system 180 charges a fee that is payable to the game provider by the advertiser. At step 440, the spelling game server system 180 awards any non-bonus reward to the player that results from his turn, where the non-bonus reward may include the usual points accrued in the game, other than bonus word rewards, according to the game rules. At step 442, the spelling game server system 180 updates the player's social media applications with a description of his turn including any bonus and non-bonus reward that is awarded. At step 444, the spelling game server system 180 determines whether the game is over after the player's turn, according to the game rules. If the game is over, then the method 400 proceeds to step 446, where the spelling game server system 180 updates the player's social media applications with a description of the game results. The method 400 then terminates.

If, however, the game is not over, the method 400 proceeds to step 448, where the spelling game server system 180 provides replacement letters to the player for those letters played during the most recent turn. The method 400 then proceeds to step 426, described above, where another player may take a turn spelling words.

Returning to step 434, if a bonus word is not included in the newly spelled words, then the method 400 proceeds to step 440, described above.

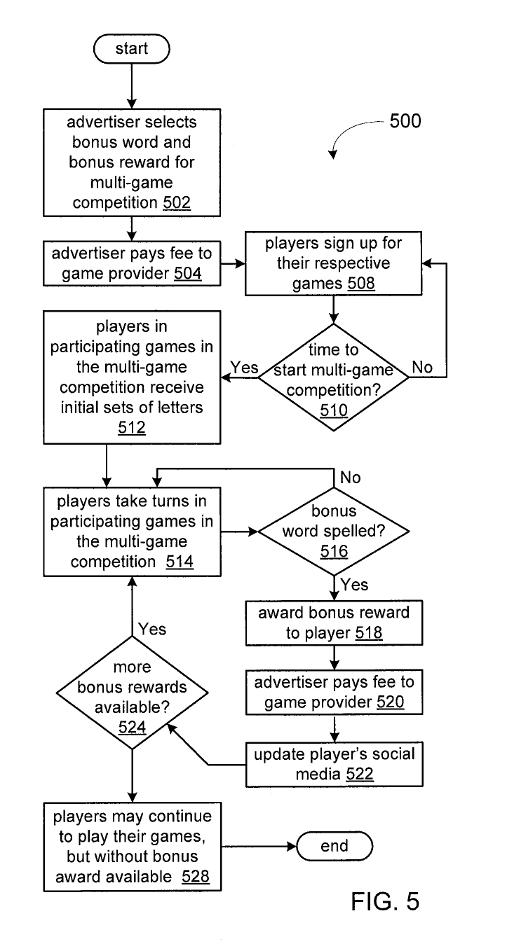

FIG. 5 sets forth a flow diagram of method steps for distributing bonus awards to players of a spelling game, according to another embodiment of the present invention. Although the method steps are described in conjunction with the systems of FIGS. 1A-3, persons of ordinary skill in the art will understand that any system configured to perform the method steps, in any order, is within the scope of the present invention.

A method 500 begins at step 502, where an advertiser selects a bonus word and a corresponding bonus reward for a multi-game competition, which may include race bonus rewards. The selected bonus rewards may also include the bonus rewards described above in conjunction with FIG. 4. At step 504, the spelling game server system 180 charges a fee that is payable to the game provider by the advertiser. At step 508, players sign up for their respective games, in a fashion similar to that described in conjunction with the flow diagram of FIGS. 4A-4B. The players may also pay a fee to play the games. At step 510, in order to provide a mechanism for all the games in the multi-game competition to start at the same time, the spelling game server system 180 determines whether a given time has been reached to start the multi-game competition. In some embodiments, the games may start at any time after the race bonus rewards are announced. In some embodiments, a player who signs up first may be granted a head start before other players. If the time to start has not been reached, then the method 500 proceeds to step 508, where more players may sign up for more games. If the time to start has been reached, then the method 500 proceeds to step 512, where the spelling game server system 180 provides initial sets of letters to players in participating games in the multi-game competition. At step 514, players take turns in participating games in the multi-game competition. An example embodiment of the flow for a game is illustrated in steps 426 through 448 of FIGS. 4A-4B.

At step 516, the spelling game server system 180 determines whether a player has spelled a bonus word. If no player spelled a bonus word, then the method 500 proceeds to step 514, described above. If, however, a player spelled a bonus word, then the method 500 proceeds to step 518, where the spelling game server system 180 awards a bonus reward to the corresponding player. At step 520, the spelling game server system 180 charges a fee that is payable to the game provider by the advertiser, where the fee is associated with the bonus award. At step 522, the spelling game server system 180 updates the social media applications associate with the player who won the bonus award with a description that announces the player's victory.

At step 524, the spelling game server system 180 determines whether more bonus awards are available in the current multi-game competition. If more bonus rewards are available, then the method 500 proceeds to step 514, described above, where the players continue competing for the remaining bonus rewards. If no more bonus rewards are available, then the method 500 proceeds to step 528, where the players may continue to play their games in the multi-game competition, but without bonus award available. At the completion of all remaining games, the method 500 terminates.

In some embodiments of the invention, players in the same game may work together so that the players may split the bonus reward. In these embodiments, the 180, the spelling game server system 180 may require the players to agree to split the bonus reward before the game starts, or require the payers agree to split the bonus reward before a bonus word is played, or allow the players to decide to split the bonus reward after a bonus word is played, or require that bonus rewards be split. Players working together add to the allure of social media, especially for race bonus rewards, and may, therefore, have added value for the game provider. Some embodiments provide all players of the game receive a bonus reward, even though one particular player plays the bonus word. In some embodiments, players may be able to see all the letters of one or more other players, so as to encourage players to work together to win and split a bonus reward.

In some embodiments of the invention, the bonus word may not be in the standard dictionary for the game, and therefore is be added to the set of allowed words. Sometimes, the bonus word may not be spelled with the default set of letters provided to all players. For example, if there is only one “X” letter in the game, then the word “XEROX” could not be spelled with the standard letter set. Under these circumstances, additional letters may be added to the game. In some embodiments, additional letters are included so that two players may spell the bonus word. In other embodiments, for any particular letter in the alphabet, the game has at least twice the number of the particular letter as in the bonus word, minus one, which allows at least two players to have the potential to play the bonus word, assuming at least one of the particular letters has been played. In some embodiments, a wild card letter tile (such as a “blank” tile) may represent a non-alphabetic character, including, without limitation, a hyphen, an apostrophe, or an exclamation, where one or more bonus words include non-alphabetic characters.

In some embodiments of the invention, the player who initiates the game may select the bonus word before other players have been invited. In other embodiments, the other players may be invited before the bonus word is selected. In yet other embodiments, the bonus word may be selected only after the other players accept playing the game. In yet other embodiments, the bonus word may be selected after the game has started. In an alternative embodiment, the players may choose or vote on the selection of the bonus word, either by unanimous or majority vote. In some embodiments, any timing relationship between players accepting the game and selection of the bonus word may be allowed.

In some embodiments of the invention, letter and word multipliers, such as double letter, triple letter, etc. or double word, triple word, etc. squares may be applied to the bonus reward, and, in other embodiments, no such multiplication of the bonus reward may be provided.

In some embodiments of the invention, all bonus words, or a subset of the bonus words, from all advertisers are available to be played to win their respective bonus rewards. Advertisers may set a time interval between a start time and an end time, where certain bonus words may be played to win a bonus reward.

In some embodiments of the invention, for particular games, the bonus word or words may be selected at random from the set of available bonus words. In some embodiments, the players may not know the bonus word until the game starts, at which time one or more bonus words may be selected at random.

In some embodiments of the invention, audio of video associated with one or more of the ads 240, 241, 242, 243, or 244 within the user interface layout 200 may be used to cheer on the player to play the bonus word, thereby providing additional advertising for the advertiser.

In some embodiments of the invention, the player who plays the bonus word may only collect the bonus reward if he wins the game via the non-bonus rewards. That is, the player win the game according to the game's standard rules and scoring, not including bonus rewards, in order to claim the bonus reward.

In some embodiments of the invention, the bonus word may be known to the players, but the bonus reward may not be revealed until after the bonus word has been played. The bonus reward may be generated at random after the bonus word has been played.

In some embodiments of the invention, a bonus word may become available when a player is able play the bonus word with the then current letter set, and the list of bonus words may be hidden from the players. In other embodiments, a bonus word may become available when a player has a particular fraction of the letters needed to play the bonus word.

In some embodiments of the invention, the name of the game provider may always be available as a bonus word. For example, if Facebook is the game provider, then spelling FACEBOOK may always win a bonus reward.

In some embodiments of the invention, players may be limited to a maximum number of games that include bonus words, as measured over a period of time. This may be a per-day, per-week, per-month, etc. limitation on the number of games the players may play that include bonus words.

In some embodiments of the invention, an advertiser may choose to limit the number of bonus rewards awarded over a time period. As examples, an advertiser may choose to award a maximum of ten coupons per day, or a maximum of $100 per week.

In some embodiments of the invention, the start of a game, or the turns during a game, may be automatically posted on social media, such as on Facebook. The postings may include the bonus word and the bonus reward. In some embodiments, when advertisers add a new bonus words to the set of available bonus words, an announcement may be posted to social media of one or more players.

In some embodiments of the invention, there may be an “honor roll” for players who have won the highest number of bonus rewards, or have won the most value in bonus rewards.

In some embodiments of the invention, the bonus reward may only be awarded if a player plays all of his letters on the turn where the bonus word is played. This option may make winning a bonus reward extra challenging.

In some embodiments of the invention, small bonus rewards may be awarded for using a fraction of the letters in the bonus word.

In some embodiments of the invention, any particular computing device may be limited to being used to play a limited number of games that include a bonus reward, such as one or two games, to severely restrict the number of games a particular person may play.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

We claim:

1. A non-transitory computer-readable storage medium including instructions that, when executed by a processor, cause the processor to distribute bonus awards associated with a spelling game, by performing the steps of:
defining a first subset of letters included in a plurality of letters;
defining a set of allowed words that includes a bonus word;
receiving one or more letters from the first subset of letters, wherein:
the subset of letters comprises at least one newly spelled word, and
the at least one newly spelled word is included in the set of allowed words; and
awarding a first reward based on the at least one newly spelled word, wherein the first reward comprises a bonus reward when the at least one newly spelled word comprises at least a portion of the bonus word.

2. The non-transitory computer-readable storage medium of claim 1, wherein the at least one newly spelled word shares a letter with a previously spelled word.

3. The non-transitory computer-readable storage medium of claim 1, further comprising the step of causing a first payment to be received when the game starts.

4. The non-transitory computer-readable storage medium of claim 1, further comprising the step of causing a first payment to be received when the bonus reward is awarded.

5. The non-transitory computer-readable storage medium of claim 1, further comprising the step of causing a first payment to be received when the bonus word is associated with the bonus reward.

6. The non-transitory computer-readable storage medium of claim 1, further comprising the steps of:
receiving a selection of the first bonus word from a plurality of bonus words; and
causing a first payment to be received when the selection of the first bonus word is received.

7. The non-transitory computer-readable storage medium of claim 1, wherein the set of allowed words includes words found in a language dictionary, and the language dictionary does not include the bonus word.

8. The non-transitory computer-readable storage medium of claim 1, wherein the set of allowed words includes words found in a language dictionary, and the language dictionary also includes the bonus word.

9. The non-transitory computer-readable storage medium of claim 1, wherein the one or more letters from the first subset of letters are received via the Internet.

10. The non-transitory computer-readable storage medium of claim 1, wherein the at least one newly spelled word comprises all letters included in the first subset of letters.

11. The non-transitory computer-readable storage medium of claim 1, wherein the first subset of letters is associated with each of a first user and a second user.

12. The non-transitory computer-readable storage medium of claim 11, wherein awarding the first reward comprises:
awarding a first portion of the first reward to the first user; and
awarding a second portion of the first reward to the second user.

13. The non-transitory computer-readable storage medium of claim 11, further comprising the step of causing all letters in the first subset of letters to be displayed to the first user and the second user.

14. The non-transitory computer-readable storage medium of claim 1, further comprising the step of adding a letter to the plurality of letters, wherein the letter is included in the bonus word.

15. The non-transitory computer-readable storage medium of claim 1, wherein the first reward is further based on receiving the one or more letters between a first point in time and a second point in time.

16. The non-transitory computer-readable storage medium of claim 1, further comprising the step of revealing the bonus reward only if the at least one newly spelled word comprises the bonus word.

17. The non-transitory computer-readable storage medium of claim 1, further comprising the step of selecting the bonus word from a plurality of bonus words.

18. The non-transitory computer-readable storage medium of claim 1, further comprising the step of causing an advertisement associated with the bonus word to be transmitted.

19. The non-transitory computer-readable storage medium of claim 1, wherein the bonus word is associated with at least one of a provider of the spelling game or an advertiser.

20. The non-transitory computer-readable storage medium of claim 1, further comprising the step of determining that a first user won the spelling game.

21. The non-transitory computer-readable storage medium of claim 1, further comprising the step of causing a message associated with the first reward to be posted on a social media platform associated with a first user.

22. The non-transitory computer-readable storage medium of claim 1, further comprising the step of determining that a first user has played less than a threshold quantity of spelling games during a first period of time.

23. The non-transitory computer-readable storage medium of claim 1, further comprising the step of determining that the one or more letters includes all letters included in the first subset of letters.

24. A method for distributing bonus awards associated with a spelling game, the method comprising:
defining a first subset of letters included in a plurality of letters;
defining a set of allowed words that includes a bonus word;
receiving one or more letters from the first subset of letters, wherein:
the subset of letters comprises at least one newly spelled word, and
the at least one newly spelled word is included in the set of allowed words; and
awarding a first reward based on the at least one newly spelled word, wherein the first reward comprises a bonus reward when the at least one newly spelled word comprises at least a portion of the bonus word.

25. The method of claim 24, wherein the at least one newly spelled word shares a letter with a previously spelled word.

26. The method of claim 24, further comprising causing a first payment to be received when the game starts.

27. The method of claim 24, further comprising causing a first payment to be received when the bonus reward is awarded.

28. A computing system, comprising:
a memory that is configured to store instructions for a program; and
a processor that is configured to execute the instructions for the program to distribute bonus awards associated with a spelling game, by:
defining a first subset of letters included in a plurality of letters;
defining a set of allowed words that includes a bonus word;
receiving one or more letters from the first subset of letters, wherein:
the subset of letters comprises at least one newly spelled word, and
the at least one newly spelled word is included in the set of allowed words; and
awarding a first reward based on the at least one newly spelled word, wherein the first reward comprises a bonus reward when the at least one newly spelled word comprises at least a portion of the bonus word.

29. The non-transitory computer-readable storage medium of claim 28, wherein the at least one newly spelled word shares a letter with a previously spelled word.

30. The non-transitory computer-readable storage medium of claim 28, wherein the processor is configured to cause a first payment to be received when the game starts.
